(19) United States
(12) Patent Application Publication
(10) Pub. No.: US 2021/0135256 A1
(43) Pub. Date: May 6, 2021

(54) PROCESS AND SYSTEM FOR ANODE OVERPRESSURE REMEDIAL ACTION IN A FUEL CELL SYSTEM

(71) Applicant: GM GLOBAL TECHNOLOGY OPERATIONS LLC, Detroit, MI (US)

(72) Inventors: Bruce J. Clingerman, North Rose, NY (US); Jie Kou, Novi, MI (US)

(73) Assignee: GM GLOBAL TECHNOLOGY OPERATIONS LLC, Detroit, MI (US)

(21) Appl. No.: 16/676,122

(22) Filed: Nov. 6, 2019

(51) Int. Cl. H01M 8/04089

(52) U.S. Cl. CPC H01M 8/04104; H01M 2250/20

(57) ABSTRACT

A process for anode overpressure remedial action in a fuel cell system is provided. The process includes monitoring a pressure of hydrogen gas at an anode of a fuel cell stack of the fuel cell system, diagnosing a mechanically stuck open injector based upon the monitored pressure, and based upon diagnosing the mechanically stuck open injector, closing a valve within a hydrogen storage system to prevent flow of the hydrogen gas from a hydrogen storage tank into a gas line connecting the hydrogen storage tank to the mechanically stuck open injector and maintaining operation of the fuel cell stack to deplete the hydrogen gas at the anode.

### INTRODUCTION

The disclosure generally relates to a process and system for anode overpressure remedial action in a fuel cell system.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, road wheels, etc.). Automobiles have historically been powered by a reciprocating-piston type internal combustion engine (ICE) assembly due to its ready availability and relatively inexpensive cost, light weight, and overall efficiency. Hybrid electric and full electric vehicles, on the other hand, utilize alternative power sources to propel the vehicle, such as electric motor generator units (MGU), and therefore minimize or eliminate reliance on a fossil-fuel based engine for tractive power.

Hybrid electric and full electric (collectively “electric-drive”) powertrains take on various architectures, some of which utilize a fuel cell system to supply power for one or more electric traction motors. A fuel cell is an electrochemical device generally composed of multiple anode electrodes that receive hydrogen (H₂), multiple cathode electrodes that receives oxygen (O₂), and multiple electrolytes interposed between each anode and cathode. An electrochemical reaction is induced to oxidize hydrogen molecules at the anode to generate free protons (H+), which are then passed through the electrolyte for reduction at the cathode with an oxidizing agent, such as oxygen. This reaction creates electrons at the anode, some of which are redirected through a load, such as a vehicle's traction motor or a non-vehicular load requiring stationary power generation, before being sent to the cathode. Such a fuel cell can be used in combination with other fuel cells to form a fuel cell stack. This stack of fuel cells or fuel cell stack can be electrically connected to each other, for example, in series, such that the voltage supplied by each fuel cell is added to the next, such that a total voltage supplied by the fuel cell stack is the sum of the voltages of each of the stacked fuel cells.

Hydrogen gas is supplied to the anode by an injector, an electromechanically operated device which selectively opens to provide hydrogen gas and selectively closes to stop the flow of hydrogen gas to the anode.

### SUMMARY

A process for anode overpressure remedial action in a fuel cell system is provided. The process includes monitoring a pressure of hydrogen gas at an anode of a fuel cell stack of the fuel cell system, diagnosing a mechanically stuck open injector based upon the monitored pressure, and based upon diagnosing the mechanically stuck open injector, closing a valve within a hydrogen storage system to prevent flow of the hydrogen gas from a hydrogen storage tank into a gas line connecting the hydrogen storage tank to the mechanically stuck open injector and maintaining operation of the fuel cell stack to deplete the hydrogen gas at the anode.

In some embodiments, the process further includes shutting down the fuel cell stack once the monitored pressure remains below a threshold pressure for a selected time period.

In some embodiments, maintaining operation of the fuel cell stack is based upon preventing the pressure of the hydrogen gas at the anode from exceeding a fuel cell hardware pressure limit.

In some embodiments, the process further includes closing a plurality of valves within the hydrogen storage system to prevent flow of the hydrogen gas from a plurality of hydrogen storage tanks into the gas line connecting the hydrogen storage tank to the mechanically stuck open injector.

In some embodiments, the mechanically stuck open injector includes a first injector, and the process further includes closing a second injector.

In some embodiments, the process further includes, based upon diagnosing the mechanically stuck open injector, opening an anode bleed valve to permit the hydrogen gas to exit an anode gas line of the fuel cell stack.

In some embodiments, the process further includes, based upon diagnosing the mechanically stuck open injector, closing an anode drain valve operable to release by-product water from the fuel cell system.

In some embodiments, the process further includes, based upon diagnosing the mechanically stuck open injector, commanding increased pressure from an air compressor supplying pressurized air to the fuel cell stack and opening a cathode bypass valve.

In some embodiments, the process further includes, based upon diagnosing the mechanically stuck open injector, partially closing a cathode backpressure air valve to increase a cathode pressure of the fuel cell stack and control a difference in pressure between the pressure of the hydrogen gas at the anode and the cathode pressure.

In some embodiments, the process further includes, based upon diagnosing the mechanically stuck open injector, monitoring a decrease in a difference in pressure between the pressure of the hydrogen gas at the anode and the cathode pressure of the fuel cell stack and, in response to the monitored decrease, closing the anode bleed valve.

In some embodiments, the process further includes, based upon diagnosing the mechanically stuck open injector, opening an anode drain valve operable to release by-product water from the fuel cell system and releasing the hydrogen gas through the anode drain valve, determining a hydrogen gas component within a fuel cell exhaust line, and closing the anode drain valve when the hydrogen gas component exceeds a threshold emissions value.

According to one alternative embodiment, a process for anode overpressure remedial action in a fuel cell system is provided. The process includes, within a computerized fuel cell system control module, operating programming to monitor a pressure of hydrogen gas at an anode of a fuel cell stack of the fuel cell system, diagnose a mechanically stuck open injector based upon the monitored pressure, and, based upon diagnosing the mechanically stuck open injector, closing a valve within a hydrogen storage system to prevent flow of the hydrogen gas from a hydrogen storage tank into a gas line connecting the hydrogen storage tank to the mechanically stuck open injector, maintaining operation of the fuel cell stack to deplete the hydrogen gas at the anode, opening an anode bleed valve to permit the hydrogen gas to exit an anode side of the fuel cell stack, commanding increased pressure from an air compressor supplying pressurized air to the fuel cell stack, opening a cathode bypass valve, partially closing a cathode backpressure air valve to increase a cathode pressure of the fuel cell stack and control a difference in pressure between the pressure of the hydrogen gas at the anode and the cathode pressure, monitoring a decrease in a difference in pressure between the pressure of the hydrogen gas at the anode and the cathode pressure of the fuel cell stack, and, in response to the monitored decrease, closing the anode bleed valve

In some embodiments, the process further includes shutting down the fuel cell stack once the monitored pressure remains below a threshold pressure for a selected time period.

In some embodiments, maintaining operation of the fuel cell stack is based upon preventing the pressure of the hydrogen gas at the anode from exceeding a fuel cell hardware pressure limit.

In some embodiments, the process further includes closing a plurality of valves within the hydrogen storage system to prevent flow of the hydrogen gas from a plurality of hydrogen storage tanks into the gas line connecting the hydrogen storage tank to the mechanically stuck open injector.

According to one alternative embodiment, a system for anode overpressure remedial action in a fuel cell system is provided. The system includes a fuel cell stack of the fuel cell system including an anode, a pressure sensor operable to monitor a pressure of hydrogen gas at the anode, an injector operable to selectively provide a flow of the hydrogen gas to the anode, a hydrogen storage tank, a gas line connecting the hydrogen storage tank to the injector, and a valve operable to selectively seal off the hydrogen storage tank. The system further includes a computerized fuel cell system control module programmed to monitor data from the pressure sensor, diagnose a mechanically stuck open injector based upon the monitored data, and, based upon diagnosing the mechanically stuck open injector, closing the valve operable to selectively seal off the hydrogen storage tank and maintaining operation of the fuel cell stack to deplete the hydrogen gas at the anode.

In some embodiments, the system further includes an anode bleed valve operable to selectively permit the hydrogen gas to flow from a gas line connecting the injector to the anode to a gas line connected to a cathode of the fuel cell stack, and the computerized fuel cell system control module is further programmed to, based upon diagnosing the mechanically stuck open injector, open the anode bleed valve.

In some embodiments, the system further includes an air compressor supplying compressed air to the gas line connected to the cathode of the fuel cell stack and a cathode bypass valve selectively permitting air within the gas line connected to the cathode of the fuel cell stack to bypass the cathode of the fuel cell stack, and the computerized fuel cell system control module is further programmed to, based upon diagnosing the mechanically stuck open injector, ramp up the air compressor to increase pressure within the gas line connected to the cathode of the fuel cell stack and open the cathode bypass valve.

In some embodiments, the computerized fuel cell system control module is further programmed to, subsequent to diagnosing the mechanically stuck open injector, diagnose a drop in the pressure of the hydrogen gas at the anode based upon the monitored data and, based upon the diagnosed drop in the pressure of the hydrogen gas at the anode, close the anode bleed valve.

In some embodiments, the system further includes an anode drain valve operable to release by-product water from the fuel cell system, and the computerized fuel cell system control module is further programmed to release the hydrogen gas through the anode drain valve.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary fuel cell system, in accordance with the present disclosure;

FIG. 2 illustrates an exemplary fuel cell system control module, in accordance with the present disclosure;

FIG. 3 is a flowchart illustrating an exemplary process to initiate a process for anode overpressure remedial action, in accordance with the present disclosure;

FIG. 4 is a flowchart illustrating an exemplary process to initiate a process for anode overpressure remedial action, in accordance with the present disclosure;

FIG. 5 graphically illustrates data plots showing pressures within an exemplary fuel cell system wherein an injector is mechanically stuck open and a fuel cell stack of the fuel cell system is immediately shut down, in accordance with the present disclosure; and

FIG. 6 graphically illustrates data plots showing pressures within an exemplary fuel cell system wherein an injector is mechanically stuck open and a process for anode overpressure remedial action is operated, in accordance with the present disclosure;

FIG. 7 illustrates an exemplary fuel cell stack and an exemplary valving system useful to control flows of hydrogen gas and compressed air useful to operating the fuel cell stack, in accordance with the present disclosure; and

FIG. 8 graphically illustrates pressures within a fuel cell system during operation of an alternative exemplary process for anode overpressure remedial action, in accordance with the present disclosure.

### DETAILED DESCRIPTION

An injector delivers a flow of pressurized hydrogen gas to an anode in a fuel cell electric vehicle. A hydrogen storage system (HSS) is a system including at least one tank of hydrogen gas, at least one valve controlling flow of the hydrogen gas, and gas lines delivering flows of pressurized hydrogen gas to a fuel cell stack. In some applications where oxygen is scarce, an oxygen tank would similarly need to be supplied, however, with the availability of ambient atmosphere, pressurized air is utilized to supply oxygen gas needed for the reaction. While embodiments illustrated herein utilize pressurized air, it will be appreciated that similar systems and processes could be utilized underwater or outside the atmosphere with such oxygen tanks.

Pressures within the gas supply lines must be significantly higher than ambient air pressure to deliver a desired amount of the hydrogen gas upon demand. In one exemplary embodiment, pressures in a high-pressure gas line in high-pressure gas lines can exceed 50,000 kPa. Frequently, a pressure regulator is used to create a mid-pressure line from the high-pressure line, receiving a high-pressure flow of hydrogen gas and permitting a capped or limited pressure of hydrogen gas to exit the pressure regulator. Such a gas line attached to the output of the pressure regulator can be described as a mid-pressure line. Under normal operation, injectors vary between open and closed states to deliver a desired anode pressure or hydrogen gas pressure at the anode.

An injector, being an electromechanical device, may experience a fault and be stuck in an open condition. One process in the art in reaction to a stuck open injector is to command a quickstop of the fuel cell stack and the HSS, shutting hydrogen gas valves in the HSS and taking off stack load. However, such a quickstop process may result in an overpressure condition, with fuel cell stack hardware and/or anode plumbing hardware breaking from the excessive pressure of the hydrogen gas. Even after valves within the HSS are closed, high-pressure within the gas lines may flow through the mechanically stuck open injector, causing an overpressure condition at the anode, which may damage the fuel cell stack or anode plumbing, each of which are not designed to contain hydrogen pressure at the high-pressure that exists within the gas lines.

A process and system for anode overpressure remedial action are provided. Anode pressure or hydrogen gas pressure at the anode is monitored during injector off times. A mechanically stuck open injector can be diagnosed based upon anode pressure rising when the injector is commanded to be closed. Based upon this diagnosis, the disclosed process can command closure of valves within the HSS to stop hydrogen gas from entering the gas lines from the hydrogen storage tank and additionally command the fuel cell stack to remain in operation, with hydrogen gas being consumed by the fuel cell stack to mitigate rising pressure at the anode.

As hydrogen gas is consumed and pressure within the gas lines decreases, the system can be brought to a shut down state without permitting high-pressure hydrogen within the gas lines to damage the fuel cell stack or anode plumbing hardware. In one exemplary embodiment, once pressure within the fuel cell stack or within gas lines feeding the fuel cell stack is below a threshold level for a threshold time (for example, pressure within the gas lines being below 300 kPa gage for a span of 1 second), then a normal quickstop can be initiated including shutting down the fuel cell stack load.

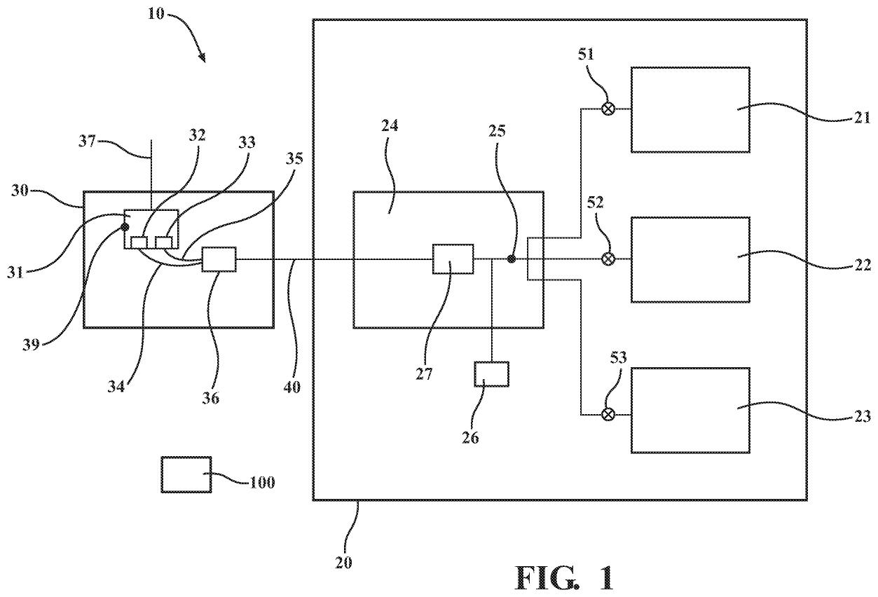

Referring now to the drawings, wherein like reference numbers refer to like features throughout the several views, FIG. 1 schematically illustrates an exemplary fuel cell system. Fuel cell system 10 is illustrated including hydrogen storage system 20 and fuel cell system 30. Hydrogen storage system 20 includes hydrogen storage tank 21, hydrogen storage tank 22, and hydrogen storage tank 23. Hydrogen storage system 20 further includes gas handling unit 24, which include high-pressure sensor 25 and pressure regulator 27 configured to regulate pressure within gas line 40 and prevent pressure spikes. Gas handling unit 24 additionally connects with refilling port 26 configured to permit charging of hydrogen storage tank 21, hydrogen storage tank 22, and hydrogen storage tank 23 with hydrogen gas. Fuel cell system 30 includes fuel cell stack 31, which is configured to react hydrogen gas and oxygen gas for the purposes of generating electrical power. Fuel cell stack 31 includes a plurality of cathodes and anodes. Fuel cell stack 31 includes fuel cell technology familiar to those having skill in the art and will not be discussed in detail herein. Fuel cell system 30 includes injector 32 and injector 33, each configured to selectively open to deliver a flow of pressurized hydrogen gas to fuel cell stack 31 and selectively close to cease the flow of pressurized hydrogen gas to fuel cell stack 31. Hydrogen gas flows through gas line 40 into fuel cell system 30, wherein the hydrogen gas is conditioned by heat exchanger 36 to regulate temperature of the hydrogen gas and is subsequently divided into first injector feed line 34 supplying hydrogen gas to injector 32, and second injector feed line 35 supplying hydrogen gas to injector 33. Additional pressure sensors and temperature sensors useful in the art may be placed at various locations throughout fuel cell system 10. Check valves, pressure relief valves, and other flow control and conditioning devices useful in the art may be placed at various locations throughout fuel cell system 10. Fuel cell system 30 includes at least one pressure sensor 39 in position to and operative to monitor an anode pressure or a hydrogen gas pressure at the anode of fuel cell stack 31.

Each of hydrogen storage tank 21, hydrogen storage tank 22, and hydrogen storage tank 23 can include a valve 51, valve 52, and valve 53, respectively, configured to selectively permit or block a flow of hydrogen gas from the tanks to gas handling unit 24. In an alternative configuration, a single valve can be used to selectively permit or block a flow of hydrogen gas at a single point, for example, at the location of high-pressure sensor 25.

Fuel cell exhaust line 37 exits fuel cell system 10 and expels water and any other reaction byproducts out of the system.

The valves, sensors, injectors, and other controllable aspects of fuel cell system 10 are electronically connected to and controlled by fuel cell system controller 100. Fuel cell system controller 100 is a computerized device operable to execute programming configured to control various aspects of the use and management of fuel cell system 10. Fuel cell system controller 100 can be electronically connected with valves, sensors, injectors, and other system components through a communications bus or other similar communications hardware, through wireless communications, or through other communications devices available in the art.

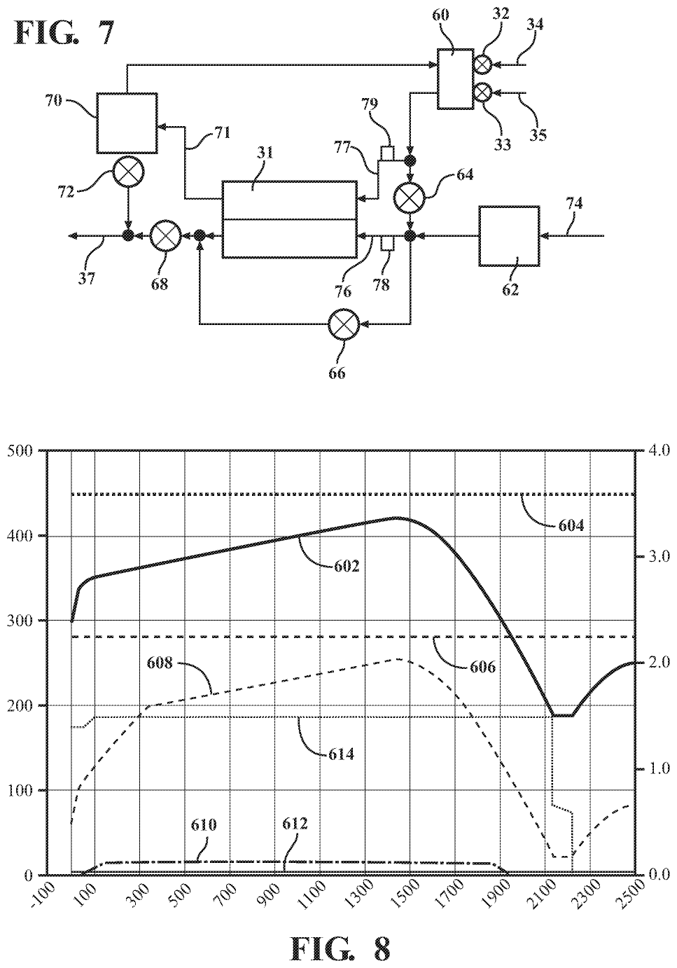

FIG. 7 illustrates an exemplary fuel cell stack and an exemplary valving system useful to control flows of hydrogen gas and compressed air useful to operating the fuel cell stack. Fuel cell stack 31 is illustrated. For simplicity sake, a single fuel cell is illustrated including a top portion including one or more anodes and a bottom portion including one or more cathodes. The illustrated “top portion” and the illustrated “bottom portion” are provided for purpose of illustration, and the locations of anodes and cathodes in relation to a fuel cell can be in any orientation. It will be appreciated that in a multi-fuel cell stack, anodes and cathodes can alternate in location, and the simplified drawing of FIG. 7 indicating flow to the top portion signifying the anodes and the flow to the bottom portion signifying the cathodes can in practice include a flow path for the anodes traversing the locations of the alternating anodes and a flow path for the cathodes traversing the locations of the alternating cathodes. A gas line 77 including a hydrogen gas flow is provided to the top portion of fuel stack 31. A gas line 76 including a compressed air flow is provided to the bottom portion of fuel stack 31. As described herein, the fuel cell stack 31 utilizes the hydrogen gas flow at the anodes and the compressed air at the cathodes to produce electrical energy for use by the vehicle or system equipped with the fuel cell stack. A plurality of illustrated valves control flows of hydrogen gas and compressed air in order to provide desired flows of hydrogen gas and compressed air to gas line 77 and gas line 76, respectively. Injector feed line 34 and injector feed line 35 from FIG. 1 are illustrated, connected with injector 32 and injector 33, respectively. Injector 32 and injector 33 each provide controlled flows of hydrogen gas into hydrogen gas intake manifold 60. Hydrogen gas from hydrogen gas intake manifold 60 flows into gas line 77 for supply into the top portion of fuel cell stack 31. Additionally, hydrogen gas may flow from hydrogen gas intake manifold 60 to anode bleed valve 64, which, when commanded to partially or fully open, may permit some portion of the hydrogen gas to avoid the top portion of fuel cell stack 31 and instead combine with compressed air and pass through the bottom portion of fuel cell stack 31.

Hydrogen gas may flow through the top portion of fuel cell stack 31 with some portion of the hydrogen gas not being reacted with the anodes of the top portion, with the unreacted portion exiting fuel cell stack 31 through gas line 71. Additionally, water as a by-product of the chemical reaction of the fuel cell stack may exit fuel cell stack 31 through gas line 71. Unreacted hydrogen gas and water flow through gas line 71 to anode water separator 70, and water may exit anode water separator 70 through anode drain valve 72. Unreacted hydrogen gas can exit anode water separator 70 and return to hydrogen gas intake manifold 60.

A flow of ambient air enters through air intake line 74. Compressor 62 is a device in the art useful for compressing air, thus providing a flow of pressurized air. Pressurized air from compressor 62 flows into gas line 76 for supply into the bottom portion of fuel cell stack 31 for reaction with the cathodes therein. Additionally, pressurized air from compressor 62 may flow from compressor 62 to cathode bypass valve 66, which, when commanded to partially or fully open, may permit some portion of the pressurized air to avoid the bottom portion of fuel cell stack 31 and instead pass directly to cathode backpressure air valve 68. Pressurized air may flow through the bottom portion of fuel cell stack 31 with some portion of the compressed air not being reacted with the cathodes of the bottom portion, with the unreacted portion exiting fuel cell stack 31 and flowing to cathode backpressure air valve 68. Pressured air flowing through cathode backpressure air valve 68 combines with water exiting anode drain valve 72, exiting the system through fuel cell exhaust line 37.

Pressure sensor 79 can be situated at various locations to monitor and generate data regarding a hydrogen gas pressure at anodes within the top portion of fuel cell stack 31. In the embodiment of FIG. 7, exemplary pressure sensor 79 is located upon gas line 77. Pressure sensor 78 can be situated at various locations to monitor and generate data regarding a pressurized air pressure at cathodes within the bottom portion of fuel cell stack 31. In the embodiment of FIG. 7, exemplary pressure sensor 78 is located upon gas line 76.

The valves of FIG. 7 can be useful to the disclosed process according to a plurality of factors. First, opening of anode bleed valve 64 can alleviate a pressure or reduce a rise in pressure within gas line 77, thereby slow a spike in hydrogen gas pressure associated with a mechanically stuck open injector valve. Opening the anode bleed valve 64 may give the system more time to react to a perceived mechanically stuck open injector valve, protecting the anodes against reaching an over maximum pressure condition as compared to ambient air pressure. Additionally, cathode backpressure air valve 68 can be partially closed or incrementally tightened, such that backpressure of pressurized air within gas line 78 can reduce a differential pressure between the top portion of the fuel cell stack 31 and the bottom portion of the fuel cell stack 31, thereby protecting seals within the fuel cell stack 31 that separate the top portion and the bottom portion from reaching an over differential pressure condition. Further, pressurized air, in some embodiments, must be prevented from entering the top portion of fuel cell stack 31, as oxygen can adversely affect catalysts upon the anodes. As hydrogen gas is depleted from gas line 77 and connecting gas lines and as the hydrogen gas pressure within gas line 77 begins to get close to being less than the pressurized air pressure within gas line 76, reverse flow through anode bleed valve 64 may be foreseeable. The anode bleed valve 64 can be pre-emptively closed to protect against pressurized air flowing backwards through anode bypass valve 64 from line 78 to line 77.

Anode bleed valve 64 can be closed in anticipation of the pressure within the gas lines of the cathodes exceeding the pressure within the gas lines of the anodes to prevent air from flowing into the gas lines of the anodes. Once the anode bleed valve 64 is fully closed, the pressure within the gas lines of the cathodes can be permitted to exceed the pressure within the gas lines of the anodes.

In different processes, anode drain valve 72 may be commanded open or closed during the disclosed processes. In one embodiment, anode drain valve 72 can be commanded open. This open anode drain valve 72 can release hydrogen gas from gas line 71, thereby reducing an overall pressure within the top portion of fuel cell stack 31. However, with accumulated water within anode water separator 70 initially blocking anode drain valve 72, that accumulated water must be purged prior to hydrogen gas being able to be released through anode drain valve 72. Therefore, opening anode drain valve 72 may not result in timely release of hydrogen gas through anode drain valve 72. Further, if hydrogen gas is released into fuel cell exhaust line 37, emissions rules must be observed, for example, requiring <8% hydrogen gas concentration by volume on a dry basis in the tailpipe. In order to utilize an open anode drain valve 72 to reduce pressure within the top portion of fuel cell stack 31, a computerized control module may determine an estimated hydrogen gas concentration within fuel cell exhaust line 37 and command anode drain valve 72 to tighten or close if the estimated hydrogen gas concentration gets too high or higher than an exhaust hydrogen gas concentration threshold. In another embodiment, anode drain valve 72 may be ordered closed during the disclosed processes.

In one embodiment, upon initiation of the disclosed process, the compressor 62 can be commanded to full speed and the cathode bypass air valve 66 can be commanded to an open state. This condition forces a large amount of air through the system, thereby reducing an impact of any hydrogen gas passing through the anode bleed valve 64 upon emissions, and lowers pressurized air pressure within gas line 76, thereby reducing likelihood of pressurized air flowing through anode bleed valve 64.

Cathode back pressure air valve 68 can be partially closed or incrementally tightened in an early portion of disclosed processes herein to increase a pressure within the bottom portion of fuel cell stack 31, thereby reducing a pressure difference between the top portion of the fuel cell stack 31, including increasing pressure hydrogen gas early in the process, and the bottom portion of the fuel stack, protecting the fuel cell stack 31 from too high of a pressure differential. Cathode back pressure air valve 68 can be subsequently opened or loosened in a late portion of the disclosed processes, to increase air content in fuel cell exhaust line 37 to aid in diluting hydrogen gas in the exhaust for emissions reasons and to reduce air pressure within the bottom portion of fuel cell stack 31 and gas line 76 to avoid pressurized air flowing through anode bleed valve 64 into gas line 77.

According to one exemplary embodiment of the disclosed process, upon diagnosing a mechanically stuck open injector, the system can: command a quickstop to the HSS, closing valves within the HSS to stop flows of hydrogen gas within the HSS; command hydrogen injectors to close (thereby closing at least one other injector that is not mechanically stuck open; command an anode bleed valve to open, thereby permitting a portion of hydrogen gas to bypass the portion of the fuel cell stack including the anodes; command anode drain valve closed; command a cathode bypass air valve to full bypass for air dilution; and control the cathode backpressure air valve, via closed loop control based upon data from the stack cathode inlet pressure sensor, to maintain a differential pressure between the anode pressure and the cathode pressure at less than a selected differential pressure value, for example, 250 kPa; and command modulation of load to consume hydrogen gas at the anode at a desired rate, preventing overpressure while preventing the anode from being starved of hydrogen gas.

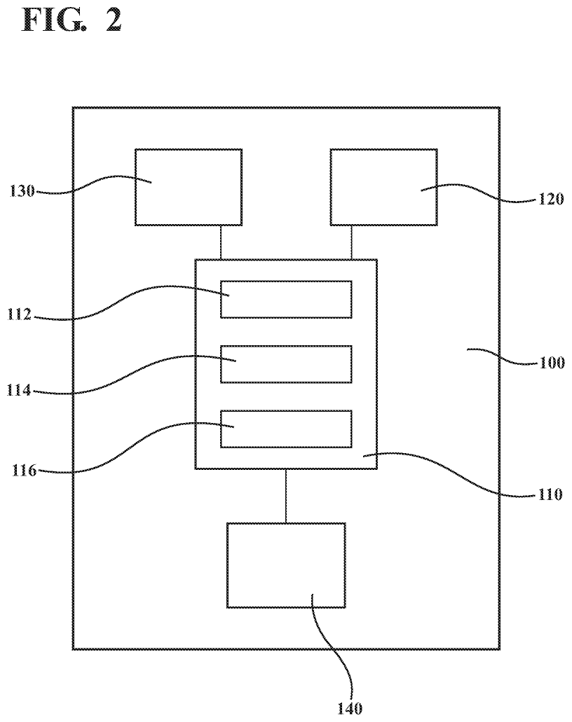

FIG. 2 illustrates an exemplary fuel cell system control module. Fuel cell system control module 100 may include processing device 110 configured to operate computerized programming. In the illustrative embodiment illustrating optional features of the disclosed system, fuel cell system control module 100 includes processing device 110, an input/output interface 130, a communications device 120, and a memory device 140. It is noted that fuel cell system control module 100 may include other components and some of the components are not present in some embodiments.

The processing device 110 may include memory, e.g., read only memory (ROM) and random-access memory (RAM), storing processor-executable instructions and one or more processors that execute the processor-executable instructions. In embodiments where the processing device 110 includes two or more processors, the processors may operate in a parallel or distributed manner. Processing device 110 may execute the operating system of the fuel cell system control module 100. Processing device 110 may include one or more modules executing programmed code or computerized processes or methods including executable steps. Illustrated modules may include a single physical device or functionality spanning multiple physical devices. In the illustrative embodiment, the processing device 110 also fuel cell operation module 112, hydrogen storage system module 114, and anode overpressure remedial action module 116 which are described in greater detail below.

The input/output interface 130 is a device that receives data from attached devices and sensors useful to provide information about the operation of a fuel cell system being monitored and transmits commands to valves, injectors, and other devices useful to control operation of the fuel cell system.

The communications device 120 may include a communications/data connection with a bus device configured to transfer data to different components of the system and may include one or more wireless transceivers for performing wireless communication.

The memory device 140 is a device that stores data generated or received by the fuel cell system control module 100. The memory device 140 may include, but is not limited to, a hard disc drive, an optical disc drive, and/or a flash memory drive.

Fuel cell operation module 112 includes programming configured to enable and control operation of the fuel cell of the fuel cell system. Fuel cell operation module 112 can include algorithms to control under normal operation opening and closing of injectors controlling flow of gases to the fuel cell and can include algorithms to monitor and/or control the electrical system attached to and receiving power from the fuel cell.

Hydrogen storage system module 114 includes programming configured to enable and control operation of a hydrogen storage system providing a flow of hydrogen gas to the fuel cell under normal operation.

Anode overpressure remedial action module 116 operates processes disclosed herein to monitor operation of the fuel cell system, diagnose a mechanically stuck open injector, command a quickstop of valves within the hydrogen storage system while commanding continued operation of the fuel cell to deplete hydrogen gas at the anode and manage shut-down of the fuel cell system in accordance with the disclosure.

Fuel cell system control module 100 is provided as an exemplary computerized device capable of executing programmed code to operate a fuel cell system including operating a process for anode overpressure remedial action in accordance with the disclosure. A number of different embodiments of fuel cell system control module 100, devices attached thereto, and modules operable therein are envisioned, and the disclosure is not intended to be limited to examples provided herein.

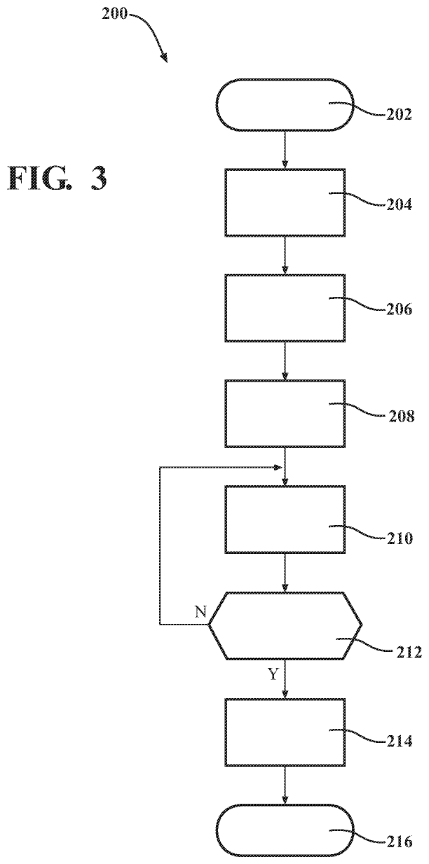

FIG. 3 is a flowchart illustrating an exemplary process to initiate a process for anode overpressure remedial action. Process 200 starts as step 202. At step 204, a fuel cell system operates. At step 206, a pressure of hydrogen gas at an anode of the fuel cell system is monitored. At step 208, a determination is made whether the monitored pressure indicates an uncontrolled rise in hydrogen gas pressure indicating a mechanically stuck open injector. At step 210, a process for anode overpressure remedial action is performed. At step 212, a determination is made whether the monitored pressure continues to exceed the threshold anode pressure, for example, determining whether anode pressure stays below 300 kPa, G for 1 second. If the anode pressure does continue to exceed the threshold anode pressure, the process returns to step 210, where the process for anode overpressure remedial action is continued. If the anode pressure is determined to not exceed the threshold anode pressure, the process advances to step 214 where a quickstop procedure including shut-down of the fuel cell is operated. At step 216, the process ends. Process 200 is provided as an exemplary process to control initiation of a process for anode overpressure remedial action. A number of similar processes are envisioned, and the disclosure is not intended to be limited to the particular examples provided herein.

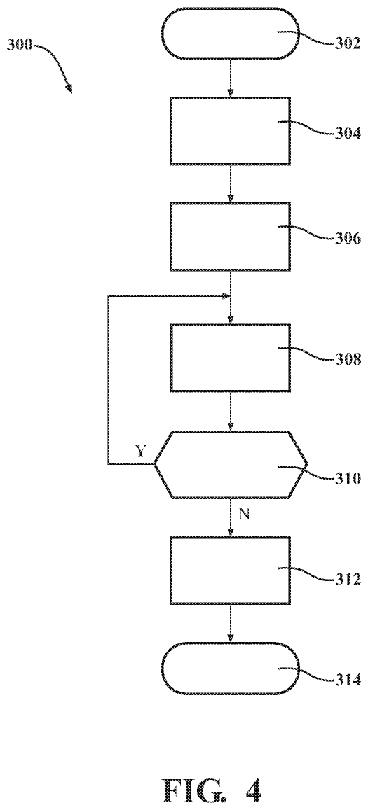

FIG. 4 is a flowchart illustrating an exemplary process to initiate a process for anode overpressure remedial action. Process 300 starts at step 302. At step 304, a determination is made that, due to a mechanically stuck open injector, an anode overpressure remedial action in accordance with the disclosure is required. At step 306, at least one valve controlling a flow of hydrogen gas from at least one hydrogen storage tank is commanded to close, sealing off a supply of hydrogen gas from entering gas lines attached to the mechanically stuck open injector. At step 308, operation of a fuel cell stack of a fuel cell system is maintained and controlled to deplete hydrogen gas at an anode of the fuel cell stack. At step 310, determination is made whether a monitored anode pressure continues to exceed a threshold anode pressure. If the monitored anode pressure does continue to exceed threshold anode pressure, the process returns to step 308 where the operation of the fuel cell stack continues to be maintained to continue depleting hydrogen gas at the anode. If the monitored anode pressure does not continue to exceed the threshold anode pressure, the process advances to step 312, where operation of the fuel cell stack is ceased. At step 314, the process ends. Process 300 is provided as an exemplary process for anode overpressure remedial action. According to one exemplary alternative embodiment, step 306 can include opening an anode bleed valve microsecond after the valve control flow from the at least one hydrogen storage tank is closed. According to another exemplary embodiment, additionally, step 306 can include simultaneously commanding the cathode bypass valve to open and initiate a command for the air compressor to ramp up. Ramping up the air compressor is descriptive of commanding the air compressor to increase an air pressure within gas lines for the cathodes. A number of similar processes are envisioned, and the disclosure is not intended to be limited to the particular examples provided herein.

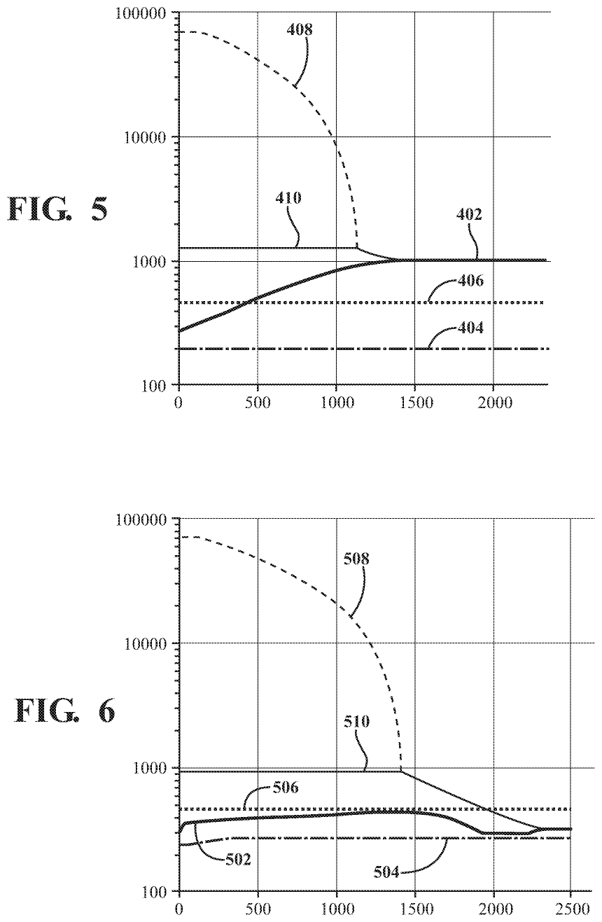

FIG. 5 graphically illustrates data plots showing pressures within an exemplary fuel cell system wherein an injector is mechanically stuck open and a fuel cell stack of the fuel cell system is immediately shut down, wherein gases remain contained within the system. The vertical axis of the graph illustrates hydrogen gas pressure in kPa on a logarithmic scale. The horizontal axis of the graph illustrates time after a hydrogen injector delivering hydrogen gas to the fuel cell stack is mechanically stuck in an open position in milliseconds. Plot 402 illustrates an anode pressure. Plot 404 illustrates a cathode pressure. Plot 406 illustrates a pressure limit for the fuel cell stack, where above anode pressure can cause damage to the fuel cell stack and/or associated hardware. Plot 408 illustrates a hydrogen gas pressure within a high-pressure gas line attached to the mechanically stuck open injector. Plot 410 illustrates a hydrogen gas pressure within a mid-pressure gas line attached to the mechanically stuck open injector. As illustrated by the plots, the values of the anode pressure, the pressure in the high-pressure line, and the pressure in the mid-pressure line converge to a middle value. In converging to the middle value, the anode pressure of plot 402 exceeds the pressure limit for the fuel cell stack of plot 406. As a result, the fuel cell stack and/or associated hardware are damaged.

FIG. 6 graphically illustrates data plots showing pressures within an exemplary fuel cell system wherein an injector is mechanically stuck open and process for anode overpressure remedial action in accordance with the present disclosure is operated. The vertical axis of the graph illustrates hydrogen gas pressure in kPa on a logarithmic scale. The horizontal axis of the graph illustrates time after a hydrogen injector delivering hydrogen gas to the fuel cell stack is mechanically stuck in an open position in milliseconds. Plot 502 illustrates an anode pressure. Plot 504 illustrates a cathode pressure. Plot 506 illustrates a pressure limit for the fuel cell stack, where above anode pressure can cause damage to the fuel cell stack and/or associated hardware. Plot 508 illustrates a hydrogen gas pressure within a high-pressure gas line attached to the mechanically stuck open injector. Plot 510 illustrates a hydrogen gas pressure within a mid-pressure gas line attached to the mechanically stuck open injector. In accordance with the process of FIG. 4, the fuel cell stack continues to operate and deplete hydrogen gas at an anode of the fuel cell stack. As illustrated by the plots, the value of the anode pressure of plot 502 rises but is controlled to remain under the pressure limit of the fuel cell stack of plot 506. As a result, the fuel cell stack and associated hardware are not damaged by the anode pressure.

FIG. 8 graphically illustrates pressures within a fuel cell system during operation of an alternative exemplary process for anode overpressure remedial action. The primary vertical axis of the graph illustrates hydrogen gas pressure in kPa. The secondary vertical axis illustrates hydrogen gas flow in grams per second. The primary vertical axis additionally illustrates current generated by the fuel cell stack. The horizontal axis of the graph illustrated time after a hydrogen injector delivering hydrogen gas to the fuel cell stack is mechanically stuck in an open position in milliseconds. Plot 602 illustrates an anode pressure as compared to atmospheric pressure. Plot 604 illustrates a pressure limit for the fuel cell stack, providing an exemplary value of 450 kPaA, where above anode pressure can cause damage to the fuel cell stack and/or associated hardware. Plot 608 illustrates a differential pressure describing anode pressure minus cathode pressure or the pressure difference across a fuel cell stack membranes and seals between the cathode and anode cells. Plot 606 illustrates a differential pressure limit for the fuel cell stack, illustrating an exemplary value of 280 kPa (another exemplary value could be 300 kPa), where above the difference between anode pressure and cathode pressure can cause damage to the fuel cell stack and/or associated hardware. Plot 610 illustrates a hydrogen gas flow through an anode bleed valve, wherein anode pressure is relieved by permitting a flow of hydrogen gas to be consumed electrochemically by the stack. Plot 612 illustrates a hydrogen gas flow through an anode drain valve. Plot 614 illustrates current generated by the fuel cell.

From zero milliseconds to approximately 30 milliseconds, anode pressure indicated by plot 602 is quickly rising, indicating that a mechanically stuck open injector has occurred. If no action is taken, plot 602 may quickly cross plot 604, indicating that the anode pressure would exceed the pressure limit for the fuel cell stack. In accordance with the disclosed process, valves in the HSS are closed and operation of the fuel cell stack is elevated or maintained, with current generated indicated by plot 614 remaining relatively constant. As described herein, when the anode bleed valve is opened, an air compressor can, in some conditions, be ramped up to reduce an impact of hydrogen gas upon exhaust emissions.

An impact of hydrogen gas content in the gas line for the cathode can depend upon temperature of the system. For example, under normal conditions, hydrogen gas is normally consumed by the fuel cell stack through catalytic combustion. However, in a cold start condition wherein ambient temperature is −30° C. or less, hydrogen gas may flow through the cathode gas lines unreacted and pass through to the exhaust system. In this cold start case, ramping up the air compressor can be beneficial to dilute the hydrogen gas content in the exhaust flow. It can similarly be beneficial to ramp up the air compressor under warm conditions to add load to the fuel cell stack for the purpose of consuming more hydrogen in accordance with the present disclosure.

At approximately 30 milliseconds, the anode bleed valve as indicated by plot 610 is opened. As a result of the opening of the anode bleed valve in conjunction with the increase of current, the steep slope of plot 602 is moderated, and between approximately 100 milliseconds and 1500 milliseconds, a rise in anode pressure remains roughly constant. However, between 100 milliseconds and 300 milliseconds, one can see that the differential pressure between the anode pressure and the cathode pressure indicated by plot 608 is significant, and if no action is taken, the differential pressure indicated by plot 608 will quickly exceed the differential pressure limit indicated by plot 606. At 300 milliseconds, the cathode backpressure air valve is partially closed or incrementally tightened, and as a result, the cathode pressure increases. As a result, the slope of plot 608 moderates. At approximately 1500 milliseconds, actions taken to reduce hydrogen gas pressure begin to lower the anode pressure, and the slope of plot 602 inverts to show a decrease in anode pressure. The differential pressure indicated by plot 608 drops with the anode pressure. At approximately 1900 milliseconds, a risk of the differential pressure indicated by plot 608 falling below zero can be identified. Accordingly, plot 610 shows the anode bleed valve closing and a hydrogen gas flow through the anode bleed valve accordingly falling to zero. At approximately 2120 milliseconds, the system is determined to be stable, a shut-down of the fuel cell stack is commanded, and accordingly current generated by the fuel cell indicated by plot 614 falls off. As a result of the bleed valve closing and the fuel cell stack shutting down, the anode pressure indicated by plot 602 and the differential pressure indicated by plot 608 stabilize and then slowly increase. FIG. 8 illustrates operation of an exemplary process to for anode overpressure remedial action which 1) prevents the anode pressure from exceeding an absolute pressure limit of the fuel cell hardware, 2) prevents a differential pressure describing anode pressure minus cathode pressure from exceeding a differential pressure limit of the fuel cell hardware, and 3) prevents pressurized air from back-flowing through the anode bleed valve and damaging a catalyst upon anodes of the fuel cell stack. Plot 612 illustrates the anode drain valve being maintained in a closed state throughout the exemplary process. The process illustrated by FIG. 8 is exemplary, a number of alternative processes are envisioned, and the disclosure is not intended to be limited to the examples provided herein.

While the best modes for carrying out the disclosure have been described in detail, those familiar with the art to which this disclosure relates will recognize various alternative designs and embodiments for practicing the disclosure within the scope of the appended claims.

What is claimed is:

1. A process for anode overpressure remedial action in a fuel cell system, comprising monitoring a pressure of hydrogen gas at an anode of a fuel cell stack of the fuel cell system;
diagnosing a mechanically stuck open injector based upon the monitored pressure;
based upon diagnosing the mechanically stuck open injector:
closing a valve within a hydrogen storage system to prevent flow of the hydrogen gas from a hydrogen storage tank into a gas line connecting the hydrogen storage tank to the mechanically stuck open injector; and
maintaining operation of the fuel cell stack to deplete the hydrogen gas at the anode.

2. The process of claim 1, further comprising shutting down the fuel cell stack once the monitored pressure remains below a threshold pressure for a selected time period.

3. The process of claim 1, wherein maintaining operation of the fuel cell stack is based upon preventing the pressure of the hydrogen gas at the anode from exceeding a fuel cell hardware pressure limit.

4. The process of claim 1, further comprising closing a plurality of valves within the hydrogen storage system to prevent flow of the hydrogen gas from a plurality of hydrogen storage tanks into the gas line connecting the hydrogen storage tank to the mechanically stuck open injector.

5. The process of claim 1, wherein the mechanically stuck open injector comprises a first injector; and
further comprising closing a second injector.

6. The process of claim 1, further comprising, based upon diagnosing the mechanically stuck open injector, opening an anode bleed valve to permit the hydrogen gas to exit an anode gas line of the fuel cell stack.

7. The process of claim 6, further comprising, based upon diagnosing the mechanically stuck open injector, closing an anode drain valve operable to release by-product water from the fuel cell system.

8. The process of claim 6, further comprising, based upon diagnosing the mechanically stuck open injector:
commanding increased pressure from an air compressor supplying pressurized air to the fuel cell stack; and
opening a cathode bypass valve.

9. The process of claim 6, further comprising, based upon diagnosing the mechanically stuck open injector, partially closing a cathode backpressure air valve to increase a cathode pressure of the fuel cell stack and control a difference in pressure between the pressure of the hydrogen gas at the anode and the cathode pressure.

10. The process of claim 6, further comprising, based upon diagnosing the mechanically stuck open injector:
monitoring a decrease in a difference in pressure between the pressure of the hydrogen gas at the anode and the cathode pressure of the fuel cell stack; and
in response to the monitored decrease, closing the anode bleed valve.

11. The process of claim 6, further comprising, based upon diagnosing the mechanically stuck open injector:
opening an anode drain valve operable to release by-product water from the fuel cell system and releasing the hydrogen gas through the anode drain valve;
determining a hydrogen gas component within a fuel cell exhaust line; and
closing the anode drain valve if the hydrogen gas component exceeds a threshold emissions value.

12. A process for anode overpressure remedial action in a fuel cell system, comprising within a computerized fuel cell system control module, operating programming to:
monitor a pressure of hydrogen gas at an anode of a fuel cell stack of the fuel cell system;
diagnose a mechanically stuck open injector based upon the monitored pressure;
based upon diagnosing the mechanically stuck open injector:
closing a valve within a hydrogen storage system to prevent flow of the hydrogen gas from a hydrogen storage tank into a gas line connecting the hydrogen storage tank to the mechanically stuck open injector;
maintaining operation of the fuel cell stack to deplete the hydrogen gas at the anode;
opening an anode bleed valve to permit the hydrogen gas to exit an anode side of the fuel cell stack;
commanding increased pressure from an air compressor supplying pressurized air to the fuel cell stack;
opening a cathode bypass valve;
partially closing a cathode backpressure air valve to increase a cathode pressure of the fuel cell stack and control a difference in pressure between the pressure of the hydrogen gas at the anode and the cathode pressure;
monitoring a decrease in a difference in pressure between the pressure of the hydrogen gas at the anode and the cathode pressure of the fuel cell stack; and
in response to the monitored decrease, closing the anode bleed valve.

13. The process of claim 12, further comprising shutting down the fuel cell stack once the monitored pressure remains below a threshold pressure for a selected time period.

14. The process of claim 12, wherein maintaining operation of the fuel cell stack is based upon preventing the pressure of the hydrogen gas at the anode from exceeding a fuel cell hardware pressure limit.

15. The process of claim 12, further comprising closing a plurality of valves within the hydrogen storage system to prevent flow of the hydrogen gas from a plurality of hydrogen storage tanks into the gas line connecting the hydrogen storage tank to the mechanically stuck open injector.

16. A system for anode overpressure remedial action in a fuel cell system, comprising a fuel cell stack of the fuel cell system comprising an anode;
a pressure sensor operable to monitor a pressure of hydrogen gas at the anode;
an injector operable to selectively provide a flow of the hydrogen gas to the anode;
a hydrogen storage tank;
a gas line connecting the hydrogen storage tank to the injector;
a valve operable to selectively seal off the hydrogen storage tank;
a computerized fuel cell system control module programmed to:
monitor data from the pressure sensor;
diagnose a mechanically stuck open injector based upon the monitored data;
based upon diagnosing the mechanically stuck open injector:
closing the valve operable to selectively seal off the hydrogen storage tank; and
maintaining operation of the fuel cell stack to deplete the hydrogen gas at the anode.

17. The system of claim 16, further comprising an anode bleed valve operable to selectively permit the hydrogen gas to flow from a gas line connecting the injector to the anode to a gas line connected to a cathode of the fuel cell stack; and
wherein the computerized fuel cell system control module is further programmed to, based upon diagnosing the mechanically stuck open injector, open the anode bleed valve.

18. The system of claim 17, further comprising:
an air compressor supplying compressed air to the gas line connected to the cathode of the fuel cell stack; and
a cathode bypass valve selectively permitting air within the gas line connected to the cathode of the fuel cell stack to bypass the cathode of the fuel cell stack; and
wherein the computerized fuel cell system control module is further programmed to, based upon diagnosing the mechanically stuck open injector, ramp up the air compressor to increase an air pressure within the gas line connected to the cathode of the fuel cell stack and open the cathode bypass valve.

19. The system of claim 18, wherein the computerized fuel cell system control module is further programmed to:
subsequent to diagnosing the mechanically stuck open injector, diagnose a drop in the pressure of the hydrogen gas at the anode based upon the monitored data; and
based upon the diagnosed drop in the pressure of the hydrogen gas at the anode, close the anode bleed valve.

20. The system of claim 16, further comprising an anode drain valve operable to release by-product water from the fuel cell system; and
wherein the computerized fuel cell system control module is further programmed to release the hydrogen gas through the anode drain valve.
